(19) United States
(12) Patent Application Publication
(10) Pub. No.: US 2026/0143338 A1
(43) Pub. Date: May 21, 2026

(54) METHODS, ARCHITECTURES, APPARATUSES AND SYSTEMS FOR PROXIMITY SERVICES (ProSe) SUPPORT IN STAND-ALONE NON-PUBLIC NETWORKS

(71) Applicant: InterDigital Patent Holdings, Inc., Wilmington, DE (US)

(72) Inventors: Taimoor Abbas, Sainte-Julie (CA); Samir Ferdi, Kirkland (CA); Anuj Sethi, Ottawa (CA); Jung Je Son, Warrington, PA (US); Guanzhou Wang, Brossard (CA)

(21) Appl. No.: 18/950,775

(22) Filed: Nov. 18, 2024

(51) Int. Cl. H04W 12/06; H04W 8/20

(52) U.S. Cl. CPC H04W 12/06; H04W 8/20

(57) ABSTRACT

Procedures, methods, architectures, apparatuses, systems, devices, and computer program products for proximity services (ProSe) support in stand-alone non-public networks are described. A wireless transmit/receive unit, WTRU, receives, from a further WTRU, a request for communication, the request for communication comprising information indicative of key data associated with the further WTRU, transmits, to a first network, a request for access for the further WTRU to a further network, the request for access comprising information indicative of the key data, receives, from the first network, a response message comprising information indicative of an authentication result and of the key data, in case the information indicative of the authentication result indicates successful authentication, transmits a request for at least one key for the further WTRU, receives security credentials for the further WTRU, and transmits, to the further WTRU, the received security credentials.

### BACKGROUND

The present disclosure is generally directed to the fields of communications, software and encoding, including, for example, to methods, architectures, apparatuses, systems directed to proximity services (ProSe) support in stand-alone non-public networks.

### SUMMARY

In a first aspect, the present principles are directed to a method at a wireless transmit/receive unit, WTRU, the method comprising receiving, from a further WTRU, a request for communication, the request for communication comprising information indicative of key data associated with the further WTRU, transmitting, to a first network, a request for access for the further WTRU to a further network, the request for access comprising information indicative of the key data, receiving, from the first network, a response message comprising information indicative of an authentication result and of the key data, in case the information indicative of the authentication result indicates successful authentication, transmitting a request for at least one key for the further WTRU, receiving security credentials for the further WTRU, and transmitting, to the further WTRU, the received security credentials.

In some embodiments, the key data is indicative of a subscription identifier.

In some embodiments, the request for communication further comprises information indicative of a code indicative of a relay service, and of at least one a key freshness indicator and a first nonce. The request for access and the response message can further comprise information indicative of the code indicative of a relay service.

In some embodiments, the method further comprises storing the information indicative of key data associated with the further WTRU.

In some embodiments, the method further comprises storing the information indicative of key data associated with the further WTRU. In response to the information indicative of the authentication result indicating successful authentication, the WTRU can retrieve the stored information indicative of key data associated with the further WTRU.

In a second aspect, the present principles are directed to a wireless transmit/receive unit, WTRU, comprising at least one processor configured to receive, from a further WTRU, a request for communication, the request for communication comprising information indicative of key data associated with the further WTRU, transmit, to a first network, a request for access for the further WTRU to a further network, the request for access comprising information indicative of the key data, receive, from the first network, a response message comprising information indicative of an authentication result and of the key data, in case the information indicative of the authentication result indicates successful authentication, transmit a request for at least one key for the further WTRU, receive security credentials for the further WTRU, and transmit, to the further WTRU, the received security credentials.

In some embodiments, the key data is indicative of a subscription identifier.

In some embodiments, the request for communication further comprises information indicative of a code indicative of a relay service, and of at least one a key freshness indicator and a first nonce. The request for access and the response message can further comprise information indicative of the code indicative of a relay service.

In some embodiments, the at least one processor is further configured to store the information indicative of key data associated with the further WTRU.

In some embodiments, the at least one processor is further configured to store the information indicative of key data associated with the further WTRU.

In some embodiments, the at least one processor is further configured to, in response to the information indicative of the authentication result indicating successful authentication, retrieve the stored information indicative of key data associated with the further WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates the PC5 Key Hierarchy for 5G ProSe UE-to-Network Relay security over User Plane;

FIG. 3 illustrates options for provisioning of credentials from Credentials Holder for U2N relay over SNPN access according to the present principles;

FIG. 4 illustrates an example of Remote UE authorization via HPLMN to access ProSe U2N relay over SNPN access according to an embodiment of the present principles;

FIGS. 5A and 5B illustrate PC5 security establishment method for 5G ProSe UE-to-Network relay communication with SNPN access over User Plane according to an embodiment of the present principles; and

FIGS. 6A and 6B illustrate PC5 security establishment method for 5G ProSe UE-to-Network relay communication with SNPN access over User Plane according to an embodiment of the present principles; and

FIG. 7 illustrates an enhanced 5G System architecture to support ProSe with access to SNPN using credentials from Credentials Holder according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

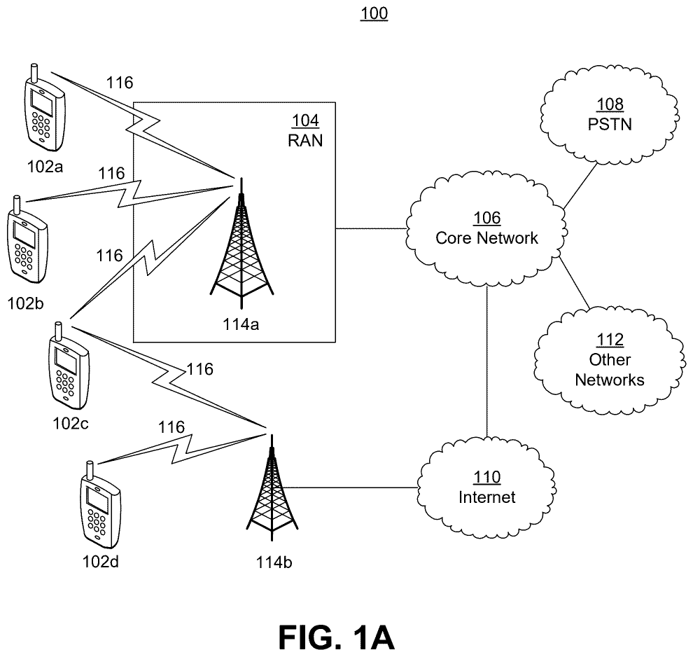

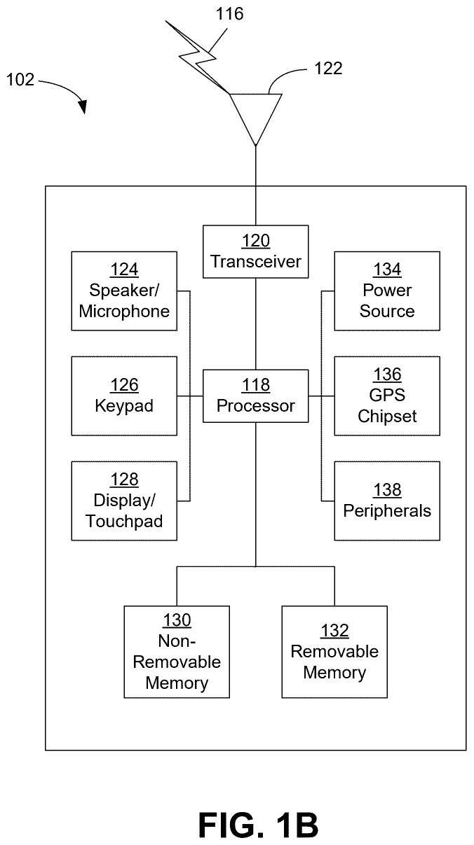

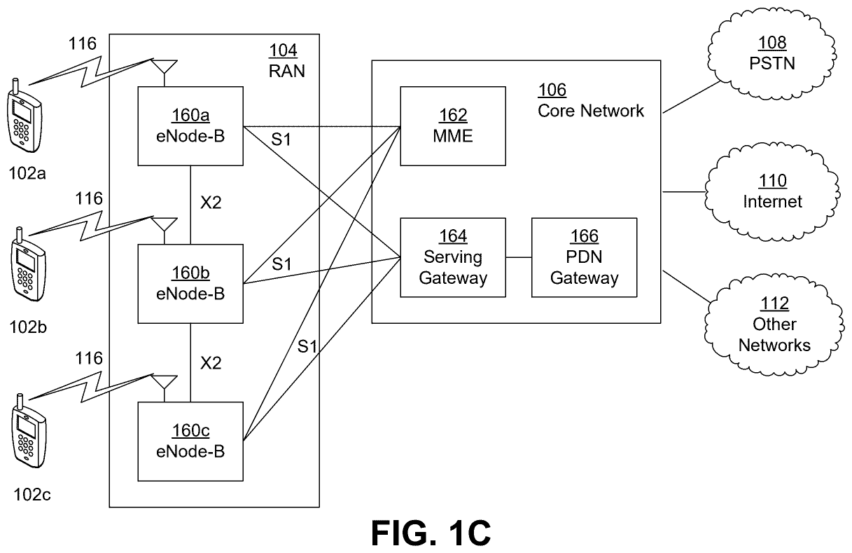

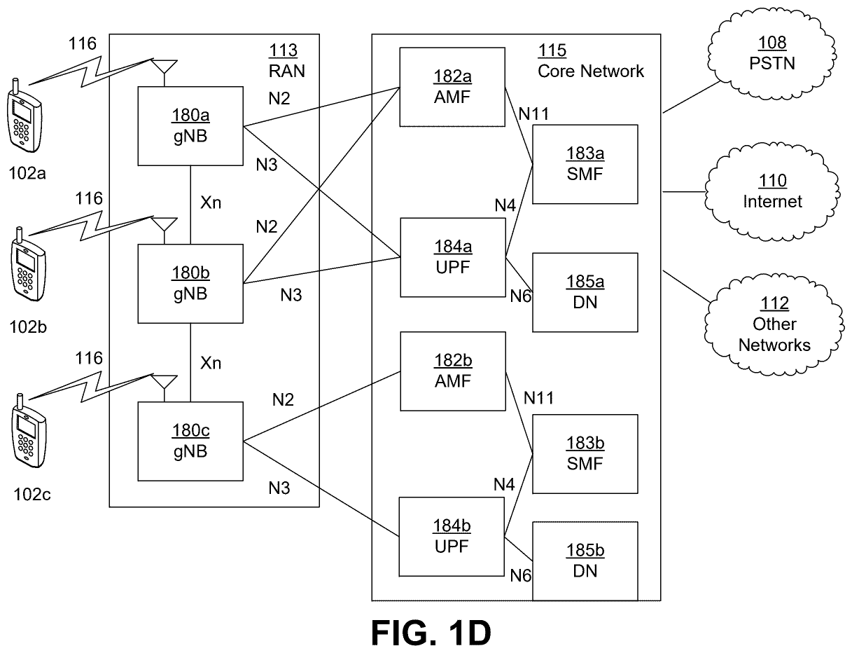

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire (i.e. obtain) location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180 c while also communicating with/connecting to another RAN such as eNode-Bs 160a, 160b, 160c. For example, WTRUs 102a, 102b, 102c may implement DC principles to communicate with one or more gNBs 180 a, 180 b, 180 c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Terminology

A number of expressions used herein are explained below.

Allowable Public Land Mobile Network (PLMN): In the case of a Mobile Station (MS) operating in MS operation mode A or B, this is a PLMN that is not in the list of “forbidden PLMNs” in the MS. In the case of an MS operating in MS operation mode C or an MS not supporting A/Gb mode (see explanation hereinafter) and not supporting Iu mode, this is a PLMN that is neither in the list of “forbidden PLMNs” nor in the list of “forbidden PLMNs for GPRS service” in the MS.

Allowable Stand-Alone Non-Public Network (SNPN): In the case of a MS operating in SNPN access operation mode over 3GPP access or a SNPN candidate that is not a SNPN selected for localized services in SNPN, an allowable SNPN is a SNPN that is not in the list of “permanently forbidden SNPNs” that include, if the MS supports access to a SNPN using credentials from a Credentials Holder, equivalent SNPNs or both associated with the selected entry of the “list of subscriber data” or the selected PLMN subscription, and that is not in the list of “temporarily forbidden SNPNs” that includes, if the MS supports access to a SNPN using credentials from a Credentials Holder, equivalent SNPNs or both associated with the selected entry of the “list of subscriber data” or the selected PLMN subscription. In the case of a MS operating in SNPN access mode and for a SNPN candidate that is a SNPN selected for localized services in SNPN, this is a SNPN that is not in the list of “permanently forbidden SNPNs for access for localized services in SNPN” which is associated with the selected entry of the “list of subscriber data” or the selected PLMN subscription, and is not in the list of “temporarily forbidden SNPNs for access for localized services in SNPN” that is associated with the selected entry of the “list of subscriber data” or the selected PLMN subscription.

Camped on a cell: The MS (Mobile Equipment (ME) if there is no Subscriber Identity Module (SIM)) is said to have camped on a cell when it has completed the cell selection or reselection process and has chosen a cell from which it plans to receive available services. It is noted that the services may be limited, and that the PLMN or the SNPN may not be aware of the existence of the MS (ME) within the chosen cell.

Current serving cell is the cell on which the MS is camped.

Home PLMN (HPLMN) is a PLMN where the Mobile Country Code (MCC) and the Mobile Network Code (MNC) of the PLMN identity match the MCC and MNC of the International Mobile Subscriber Identity (IMSI).

Visited PLMN (VPLMN) is a PLMN different from the HPLMN (if the Equivalent HPLMN (EHPLMN) list is not present or is empty) or different from an EHPLMN (if the EHPLMN list is present).

Registered PLMN (RPLMN) is the PLMN on which certain Link Release (LR) outcomes have occurred (see Table 1 in TS 23.122, Non-Access-Stratum (NAS) functions related to Mobile Station (MS) in idle mode, V18.7.0). In a shared network the RPLMN is the PLMN defined by the PLMN identity of the CN operator that has accepted the LR.

Registration is the process of camping on a cell of the PLMN or the SNPN and performing necessary LRs.

Selected PLMN is the PLMN that has been selected, manually or automatically, according to clause 3.1 of TS 23.122.

### Non-Public Networks (NPN)

A Non-Public Network (NPN) is a 5GS deployed network which is for non-public use, see 3GPP TS 22.261v 18.14.0 . An NPN is either a Stand-alone Non-Public Network (SNPN), i.e. operated by an NPN operator and not relying on network functions provided by a PLMN, or a Public Network Integrated NPN (PNI-NPN), i.e., a non-public network deployed with the support of a PLMN.

A NPN is intended for the use of a private entity, such as an enterprise or a factory. A SNPN can be identified by a combination of PLMN ID and Network Identifier (NID), where the PLMN ID may be e.g. reserved PLMN IDs for private networks (e.g., with Mobile Country Code=999).

The architecture of a 5G SNPN is based on the architecture of 5G System as depicted in Clause 4.2.3 of TS 23.501, System architecture for the 5G System (5GS); Stage 2; (Release 18) V18.6.0. The Next Generation Radio Access Network (NG-RAN) of the SNPN broadcasts the combination of PLMN IDs and NIDs. A UE operating in SNPN access mode reads the broadcast system information for available (PLMN ID+NID)'s and selects the SNPN for which it has a subscription and credentials. A SNPN-enabled UE is assumed to be configured with PLMN ID and NID of the subscribed SNPN.

The Credentials Holder (CH) in the context of SNPN refers to an entity, e.g., an AAA server, that possesses the necessary credentials for a UE to obtain authorization for SNPN access, including the SNPN access credentials, authorized identification, authentication and authorization-related credentials and security compliance. A UE with credentials from a Credentials Holder may use a similar procedure for service discovery across PLMNs as specified in clause 4.17.5 in TS 23.502 v18.14.0 with the difference that the serving PLMN is replaced by the SNPN and the HPLMN is replaced by the Credentials Holder.

Additionally, a 5G SNPN-enabled UE may access a SNPN using credentials owned by a Credentials Holder. In this case, the SNPN-enabled UE may be configured with a (user-controlled or credentials holder-controlled) prioritized list of preferred SNPNs, a credentials holder-controlled prioritized list of Group IDs for Network Selection (GINs), and a credentials holder may use the AAA server or the AUSF and UDM for primary authentication/authorization of the SNPN-enabled UE; for details, see TS 23.501, System architecture for the 5G System (5GS); Stage 2; (Release 18) V18.6.0.

### U2N Relay Discovery and Communication Security

3GPP has defined User to Network (U2N) procedures for discovery and communication including security and privacy in Release 17 (see 3GPP TS 33.503 v17.4.0 and 3GPP TS 23.304 v18.2.0).

These procedures support U2N Relay direct discovery using Model A or B. In Model A, the U2N Relay sends Annoncement discovery messages to be discovered by the Remote UE in the proximity. In Model B, the Remote UE sends Solicitation discovery messages to which discoverable U2N Relays reply with corresponding response messages.

Discovery security parameters (e.g., keys and timing information) associated with the U2N Relay Service Code (RSC) are provisioned in the Remote UE and U2N Relay and used to protect discovery messages and some sensitive parameters in the DCR message (e.g., RSC). The Remote UE/Relay is provided with security parameters by a Direct Discovery Name Management Function (DDNMF) or a Policy Control Function (PCF) or a Proximity Services (ProSe) Key Management Function (PKMF).

U2N Relay direct communication supports two alternative User Plane (UP) and Control Plane (CP) based security mechanisms where a root credential called ProSe Remote User Key (PRUK) is respectively provisioned and generated.

For CP-based, the Remote UE establishes the root credential (CP-PRUK) with the Remote UE HPLMN (AUSF/UDM/PAnF) during a ProSe authentication procedure as part of PC5 link establishment with the U2N Relay. This authentication requires the 3GPP credential stored in the Remote UE Universal Integrated Circuit Card (UICC).

For UP-based, the Remote UE is configured by its PKMF with the root credential (UP-PRUK). The UP-PRUK may also be generated as part of PC5 link establishment with the U2N Relay using a Generic Bootstrapping Architecture (GBA)-Push mechanism the also requires the 3GPP credential stored in the Remote UE UICC.

The PRUK is used to establish a PC5 link root key Key for New Radio PC5 (KNRP) shared between the Remote UE and the U2N Relay, and that is used to derive session keys and security keys. The Remote UE derives the KNRP from the PRUK while the U2N Relay receives the KNRP from the network (e.g., PKMF or AMF).

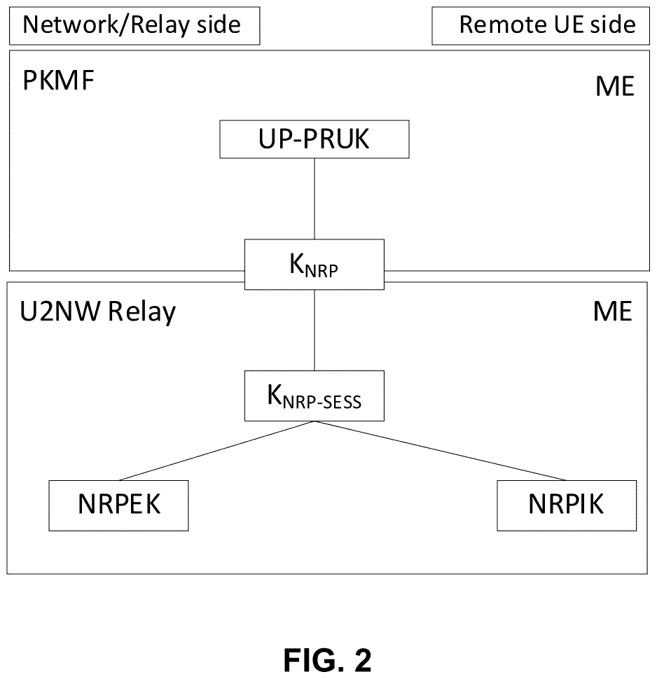

FIG. 2 illustrates the PC5 Key Hierarchy for 5G ProSe UE-to-Network Relay security over User Plane. The PKMF and the Remote UE derive from the UP-PRUK a KNRP used as the root key for the PC5 link between the Remote UE and the U2N Relay. The PKMF provides the KNRP to the U2N Relay via the User Plane during a Key request procedure, while the Remote UE derives the KNRP during the Direct Security Establishment Procedure (DSMC) over the PC5 link with the U2N Relay. The Remote UE and the U2N Relay further derive the session key and security keys from the KNRP during the DSMC procedure.

A similar key hierarchy is defined for the CP-based approach. The main difference is that the root credential (CP-PRUK) is derived by the AUSF and the Remote UE during a ProSe authentication procedure via the U2N Relay/NAS messaging.

### ProSe Support in SNPN

In Release 19 study SP-240122, the ProSe enhancement is developed to support ProSe functionality in NPN for selected scenarios without supporting roaming architecture or inter-SNPN operation. To support ProSe over NPN, the ProSe configuration over PLMN is extended to include a combination of PLMN ID and Network Identifier (NID) as an identification of a SNPN, and ProSe Discovery and Selection of UE-to-Network relays are extended to support access to an NPN via U2N relay.

To prevent that unauthorized 5G ProSe Remote UEs can gain access to an NPN via 5G ProSe UE-to-Network Relay, the existing User Plane and/or Control Plane authorization verification procedures are reused as specified in TS 33.503v17.4.0 . Additionally, to prevent that unauthorized 5G ProSe Remote UEs can gain access to a Closed Access Group (CAG) cell operated by a PNI-NPN which a 5G ProSe Remote UE is not allowed to access, the existing access control mechanisms are also reused as specified in TS 23.501 v 18.6.0 and TS 38.300v18.3.0 .

In the current Rel. 19, ProSe over SNPN is limited to the subscribed SNPN only. In other words, it is not defined how a Remote UE can access a SNPN via a ProSe UE-to-Network Relay (e.g., while out of network coverage) by means of a Credentials Holder (CH) authentication and authorization. Therefore, when the Remote UE is out of coverage of the SNPN, it may not be able to connect, via ProSe UE-to-Network Relay, to a SNPN that requires CH authorization.

It will thus be appreciated that it can be desired to enable better service coverage via ProSe in a non-public network by enhancing the 5G wireless system to enable access to a SNPN via U2N relay when the SNPN it is not a subscribed SNPN of the UE (i.e., UE access to SNPN requires CH authentication and authorization).

The present principles provide different embodiments that can be combined in certain ways for enabling ProSe services support in Stand-alone Non-Public Networks (SNPNs) that will first be briefly described.

In a first embodiment, the 5G system architecture for SNPN is enhanced with the assumption that the UEs support access to a SNPN using credentials from a Credentials Holder. To enable ProSe authentication and authorization over the user plane and over the control plane, the present principles propose three new network functions herein called 5G PKMF, 5G DDNMF and ProSe Anchor Function (PAnF) to be hosted by the Credentials Holder.

A second embodiment provides configuration options for configuring the ProSe UE, e.g., Remote UE and the UE-to-Network Relay UE, with the SNPN related configurations and credentials from the Credentials Holder.

A third embodiment proposes Remote UE provisioning for ProSe relayed SNPN access with the assumption that the Remote UE gets provisioned for relayed SNPN access while it is served by a PLMN.

A fourth embodiment proposes Remote UE link establishment with U2N relay for relayed SNPN access over the user plane.

A fifth embodiment proposes Remote UE link establishment with U2N relay for relayed SNPN access over the control plane.

As mentioned, the first embodiment provides an enhanced 5G system architecture to support ProSe services with access to a SNPN.

Based on the assumption that the UEs support access to a SNPN using credentials from a Credentials Holder, the reference 5G System architecture is enhanced for SNPN with Credentials Holder using AUSF and UDM for primary authentication and authorization and network slicing, as specified in clause 5.30.2.9.3 of TS 23.501 v 18.6.0. It is further assumed that one Credentials Holder can serve one or more SNPN.

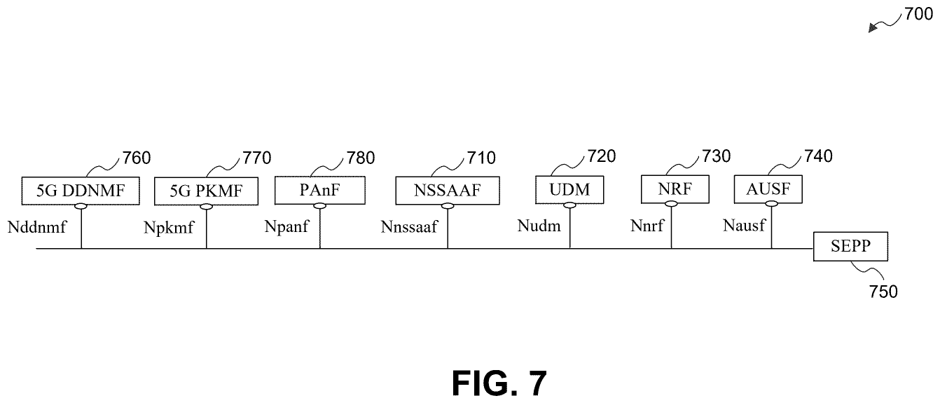

FIG. 7 illustrates an enhanced 5G System architecture to support ProSe with access to SNPN using credentials from Credentials Holder according to an embodiment of the present principles.

In addition to the architectural reference model specified in clause 5.30.2.9.3 of TS 23.501 v 18.6.0, (including e.g. NSSAAF 710, UDM 720, NRF 730, AUSF 740 and SEPP 750), the illustrated Credentials Holder 700 supports the functional entity 5G ProSe Key Management Function 770 (5G PKMF), which is a logical function. As defined in TS 33.503v 17.4.0 , the (conventional) PKMF handles the network related actions required for the key management and the security material for discovery of a 5G ProSe UE-to-Network Relay by a 5G ProSe Remote UE, for establishing a secure PC5 communication link between a 5G ProSe Remote UE and 5G ProSe UE-to-Network Relay, for discovery of a 5G ProSe UE-to-UE Relay by a 5G ProSe End UE, and for establishing a secure PC5 communication link between a 5G ProSe End UE and a 5G ProSe UE-to-UE Relay.

In case of SNPN, the 5G PKMF 770 is hosted by the Credentials Holder, which could be the same for multiple SNPNs. The 5G PKMF 770 could be the same for the ProSe UE(s), e.g., 5G ProSe remote UE, 5G ProSe UE-to-Network Relay UE, 5G ProSe U2U relay UE etc., enabled to access 5G ProSe services over a SNPN. For a SNPN-enabled ProSe UE, the 5G PKMF 770 in the Credentials Holder may provide security material per RSC per SNPN, which would enable access to the relay services allowed per SNPN for each 5G ProSe UE. Different combinations are possible to host the 5G PKMF to enable ProSe over SNPN, for example one of the three following options.

Option 1: The PKMF of a Remote UE is hosted by the HPLMN of the Remote UE, and the PKMF of the UE-to-Network Relay UE is hosted by the Credentials Holder.

Option 2: The PKMF of both the Remote UE and the UE-to-Network Relay UE are hosted by the Credentials Holder, and it could be the same PKMF for both.

Option 3: The PKMF of both the Remote UE and the UE-to-Network Relay UE are hosted by their corresponding HPLMN, however, the PKMF in the SNPN could communicate with their corresponding HPLMN to get the security material for authentication.

The address of the 5G PKMF (hosted in Credentials Holder network) is either pre-provisioned or provided by the 5G DDNMF (or the PCF) in the HPLMN of the 5G ProSe Remote UE to the 5G ProSe Remote UE, and by the 5G DDNMF (or the PCF) in the HPLMN of the 5G ProSe UE-to-Network Relay to the 5G ProSe UE-to-Network Relay during the ProSe Remote User Key Request Procedure and U2N Relay UE PKMF address request procedures, respectively.

Since the 5G PKMF in this case is hosted by the Credentials holder and may serve multiple SNPNs, the 5G PKMF in CH may therefore, upon key request from the ProSe UE, provide a list of PRUK and PRUK ID. The list includes a PRUK and PRUK ID per SNPN, e.g., SNPN specific UP-PRUK and UP-PRUK ID called SUP-PRUK and SUP-PRUK ID). The ProSe UE based on the configurations and the relay service code may select the respective PRUK and PRUK ID for PC5 connection establishment via the SNPN access.

In addition to the architectural reference model specified in clause 5.30.2.9.3 of TS 23.501 v18.6.0, the Credentials Holder in the architectural reference model shall further support the functional entity called Prose Anchor Function 780 (PAnF), which is a logical function. As defined in TS 33.503v17.4.0 , the PAnF 780 handles the network related actions required for the key management and the security material for establishing a secure PC5 communication link between a 5G ProSe Remote UE and 5G ProSe UE-to-Network Relay over Control Plane, and for establishing a secure PC 5 communication link between a 5G ProSe End UE and a 5G ProSe UE-to-UE Relay over Control Plane. The PAnF 780 shall store the Prose context info (i.e. SUPI, RSC, CP-PRUK, CP-PRUK ID) for a 5G ProSe Remote UE and the Prose context info for a 5G Prose End UE. In case of SNPN, the PAnF 780 may store additional information dedicated to SNPN access, e.g., SNPN specific CP-PRUK and CP-PRUK ID called SCP-PRUK and SCP-PRUK ID).

In addition to the architectural reference model specified in clause 5.30.2.9.3 of TS 23.501 v18.6.0, the Credentials Holder in the architectural reference model shall support the functional entity called 5G Direct Discovery Name Management Function 760 (5G DDNMF), which is a logical function handling network related actions required for dynamic 5G ProSe Direct Discovery as specified in TS 23.304v18.2.0 .

The 5G DDNMF 760 in the HPLMN may use a NR Repository Function (NRF) to discover other 5G DDNMF in a Credentials Holder for ProSe support over SNPN access, and to manage the 5G ProSe Direct Discovery service over SNPN access.

The 5G DDNMF 760 of SNPN hosted in Credentials Holder is discovered through interaction with the Credentials Holder. The UE may have the 5G DDNMF address for SNPN (either as a Fully Qualified Domain Name (FQDN) or an IP address) pre-configured or provisioned. If it is not pre-configured or provisioned, then the UE itself can generate the FQDN for use, e.g. the Network ID (NID) of the SNPN, or PLMN ID +NID of the HPLMN and SNPN.

The second embodiment provides configuration options to configure the SNPN credentials from the Credentials Holder, notably how to configure the ProSe UE, e.g., Remote UE and the UE-to-Network Relay UE, with the SNPN credentials from the Credentials Holder. In the example illustrated in FIG. 7, the 5G PKMF, 5GDDNMF and PAnF are shown as being part of the CH, but it is to be understood that other arrangements are possible; for example the 5G PKMF, 5GDDNMF and PAnF can be part of the SNPN).

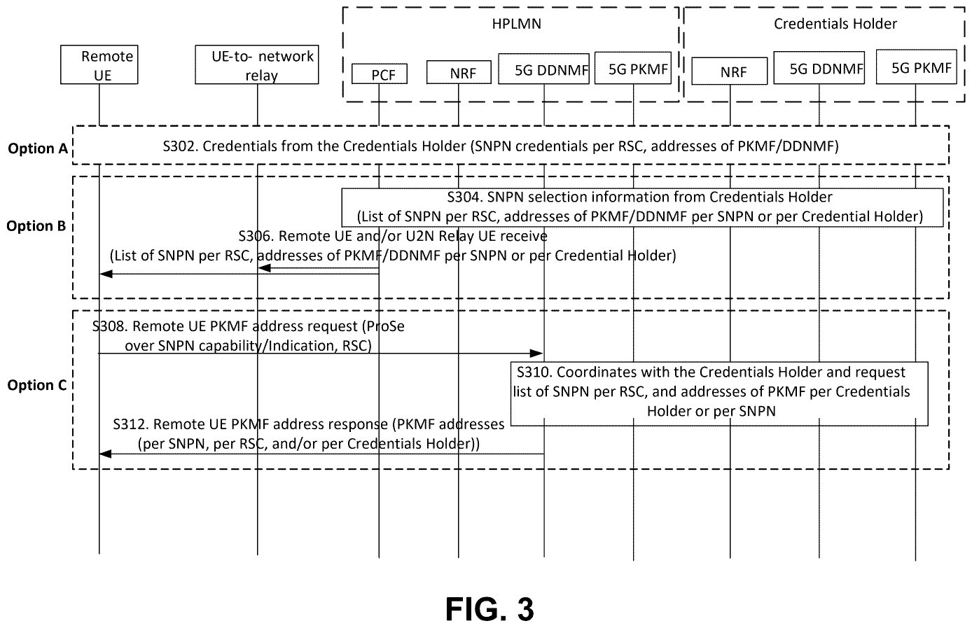

In some scenarios, e.g. in controlled environments such as enterprise and industrial networks, SNPN credentials could be pre-configured on the UE in the USIM or on the MT. Alternatively, the UE could receive the SNPN credentials using either of options A-C for provisioning of credentials from Credentials Holder for U2N relay over SNPN access illustrated in FIG. 3. For these example options, it is assumed that the ProSe UE is served by a HPLMN and that it receives SNPN related credentials from the credentials holder while connected to HPLMN.

Using option A, in step S302, in case the Remote UE supports ProSe in SNPN and the Remote UE has provided the ProSe in SNPN capabilities to the HPLMN during the NAS or ProSe procedures, e.g., the initial registration or DDNMF discovery, then the NFs, e.g., 5G DDNMF, PCF, in HPLMN could provide the IP address of the Credentials Holder to the Remote UE, and the Remote UE could request provisioning of configuration for 5G ProSe in SNPN from the Credentials Holder, which authenticates the UE and then transfers the credentials to it.

Different SNPN configurations could be provisioned per Relay Service Code, for example a user-controlled prioritized list of preferred SNPNs (e.g., a list of SNPN ID which is PLMN ID plus NID), a Credentials Holder-controlled prioritized list of preferred SNPNs, and a Credentials Holder-controlled prioritized list of GINs. The DDNMF address and the PKMF address could be provisioned per Credentials Holder.

Each SNPN may support a selected relay service identified by the RSCs, and this information is known by the Credentials Holder. Therefore, the SNPN configurations to a ProSe UE for 5G ProSe in SNPN would be per RSC to indicate the SNPN IDs of the SNPNs that allow request prose services.

Using option B, if there is an agreement between the HPLMN of a ProSe Remote UE and the Credentials Holder for SNPN access, in step S304, the Credentials Holder transmits information to the HPLMN via the NRF, e.g. SNPN configurations or SNPN selection information that may include a list of SNPN per RSC, which allow access of U2N Relay in SNPN, DDNMF and/or PKMF addresses per Credentials Holder. The NFs, e.g., 5G DDNMF, PCF, may store the SNPN selection information received from the Credentials Holder.

In step S306, the NFs may send SNPN credentials (received in step S304) to the Remote UE as part of UE Configuration Update (UCU) procedures (during which a PCF in the NFs updates a UE with configurations/parameters via the AMF), or via the DDNMF.

Using option C, in case the UE supports ProSe over SNPN access, then the UE may, in step S308, provide the ProSe over SNPN access capabilities or indication to 5G DDNMF, when requesting the PKMF address, e.g., Remote UE PKMF Request or UE-to-Network Relay UE PKMF Request.

In step S310, the 5G DDNMF obtains the address for the Credentials Holder via the NRF and communicates with the Credentials Holder to obtain the SNPN Credentials or the SNPN selection information.

In step S312, the 5G DDNMF selects an SNPN per RSC and sends the SNPN-specific credentials (e.g., list of SNPN ID, list of PKMF address per SNPN etc.) or all the SNPN credentials received in step S310 to the Remote UE and lets the Remote UE select the SNPN. The 5G DDNMF may send these credentials in response to the PKMF address request message in step S308.

The third embodiment provides Remote UE provisioning for ProSe relayed SNPN access. The ProSe UE-supporting ProSe in SNPN capability, e.g., the Remote UE, is authorized for ProSe service in SNPN by the CH over the user plane via its HPLMN. It is assumed that the Remote UE is served by the HPLMN and that it is in the coverage area of the HPLMN, and that it then could use the PDU session over the HPLMN to communicate with the network functions of the Credentials Holder, e.g., the 5G PKMF. The UE-to-Network Relay UE is assumed to be served by the SNPN and to be able to communicate, using the SNPN, with the network functions in the Credentials Holder, e.g., the 5G PKMF.

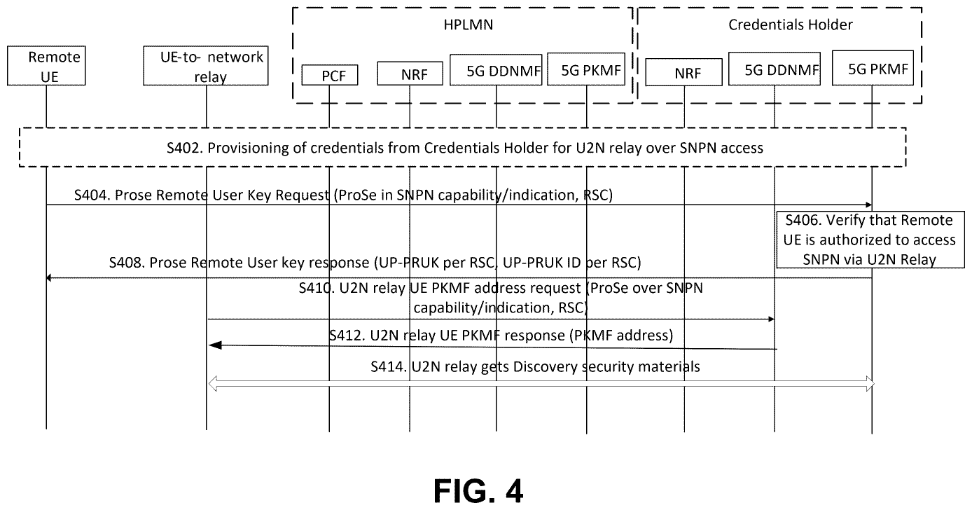

FIG. 4 illustrates an example of Remote UE authorization via HPLMN to access ProSe U2N relay over SNPN access according to an embodiment of the present principles.

In step S402, the provisioning and configuration of credentials from the Credentials Holder is performed using for example one of the options of the second embodiment, illustrated in FIG. 3.

Steps S404-S408 and steps S410-S414 described hereinafter respectively refer to the Remote User Key Request Procedure and U2N relay UE PKMF address request procedures, which may run independently and thus could be performed in parallel or in any order.

The Remote UE has received the list of SNPN per RSC, and the address(es) of PKMF per SNPN in the Credentials Holder domain. In this example, the Remote UE is served by and is in the coverage area of the HPLMN and could use the PDU session over HPLMN to establish a secure connection with the 5G PKMF in the Credentials Holder via PC8 reference point. In general, it could be any registered PLMN, e.g., HPLMN, VPLMN etc. In step S404, the Remote UE sends an UP-PRUK (ProSe Remote User Key) Request message to its 5G PKMF in the Credentials Holder. The message includes information indicating that the 5G ProSe Remote UE requests an UP-PRUK from the 5G PKMF and may additionally include information indicating ProSe in SNPN capability/indication, RSC. If the 5G ProSe Remote UE already has an UP-PRUK from this 5G PKMF, the message shall also include the UP-PRUK ID of the UP-PRUK.

In step S406, the 5G PKMF checks whether the Remote UE is authorized to receive UE-to-Network Relay services over the SNPN access. This can be done by using the Remote UE's identity associated with the key used to establish the secure connection between the Remote UE and 5G PKMF via HPLMN, as described.

If the Remote UE is authorized to receive the service, in step S408, the 5G PKMF sends an UP-PRUK and an UP-PRUK ID to the Remote UE. The Remote UE stores the UP-PRUK and the UP-PRUK ID, if included in the response message, and deletes any previously stored UP-PRUK and UP-PRUK ID for this 5G PKMF.

The UE-to-Network Relay is authorized for SNPN access and could use the SNPN to discover the 5G DDNMF, which is hosted by the Credentials Holder and serves the ProSe services over SNPN. In step S410, the UE-to-Network Relay transmits information indicating a request for the 5G PKMF address from the 5G DDNMF, and may additionally include ProSe over SNPN capability/indication, RSC. In step S412, the 5G DDNMF responds with the 5G PKMF address. In step S414, the UE-to-Network Relay establishes a secure connection via SNPN with the 5G PKMF, which is hosted by the Credentials Holder. The UE-to-Network Relay then receives the discovery security material and PC5 security policies from the 5G PKMF.

Subsequent procedures are described with reference to the fourth embodiment, 5G ProSe UE-to-Network relay communication with SNPN access over user plane, and the fifth embodiments, 5G ProSe UE-to-Network relay communication with SNPN access over control plane.

The fourth embodiment provides Remote UE link establishment with U2N relay for relayed SNPN access over user plane. The Remote UE is authorized via UE-to-Network Relay for 5G ProSe UE-to-Network Relay communication with SNPN access over user plane. It is assumed that the UE-to-Network Relay is provisioned with the credentials from the Credentials Holder for SNPN access. The Remote UE may have the credentials from the Credentials Holder for SNPN access or not; both cases are described. As an example, there are separate Credentials Holders for the Remote UE and the UE-to-Network Relay. However, it is also possible that the Remote UE and the UE-to-Network Relay have the same CH, in which case both UEs communicate with the same 5G PKMF, AUSF, PAnF and 5G DDNMF for authorization for ProSe services over SNPN access.

It is also assumed that the Remote UE is out of coverage from its HPLMN or serving SNPN, and that the only way to access the network is via the UE-to-Network Relay communication with SNPN access over the user plane.

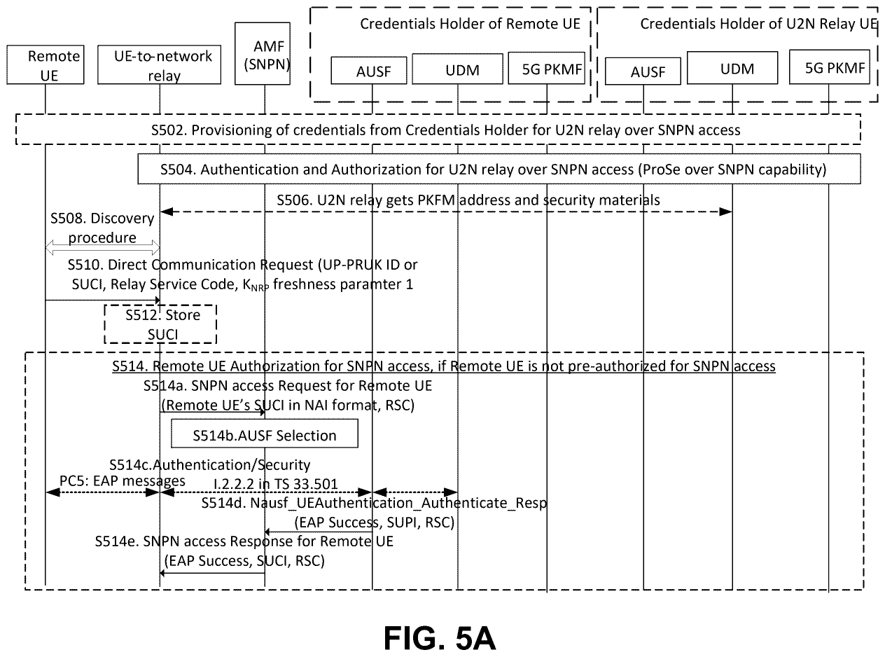

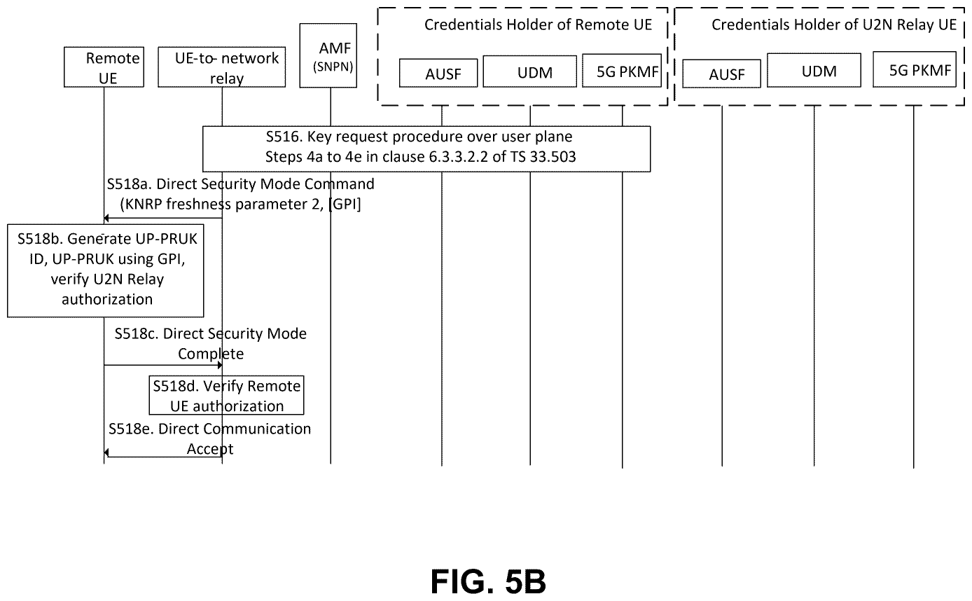

FIGS. 5A and 5B illustrate an example PC5 security establishment method for 5G ProSe UE-to-Network relay communication with SNPN access over User Plane according to an embodiment of the present principles.

In step S502, the provisioning and configuration of credentials from the Credentials Holder is performed for example using any option already described.

In step S504, the UE-to-Network (U2N) Relay is configured with credentials from the Credentials Holder, e.g. SUPI including a network-specific identifier and credentials for the key-generating Extensible Authentication Protocol (EAP) method used. The U2N Relay then performs the UE registration and primary authentication procedure for SNPN access, as specified in TS 23.502 v18.6.0 and TS 33.501v18.7.0 , respectively. The U2N Relay may additionally provide ProSe over SNPN capability during the registration procedure to get authorized for ProSe services over SNPN access.

The U2N Relay may also establish a relay PDU session over SNPN access.

In step S506, the U2N Relay performs steps S410-S414 illustrated in FIG. 4 to obtain the security material and PC5 security policy.

In step S508, the Remote UE and the U2N Relay perform a discovery procedure using the discovery parameters and discovery security material as described in TS 33.503v17.4.0 .

In step S510, the Remote UE sends, to the 5G ProSe U2N Relay, a Direct Communication Request (DCR) that includes UP-PRUK ID or a Subscription Concealed Identifier (SUCI), Relay Service Code (RSC) of the 5G ProSe UE-to-Network Relay service and KNRP freshness parameter 1.

If the Remote UE does not have a valid UP-PRUK, then the Remote UE sends a SUCI in the DCR, e. g, an onboarding SUCI that is constructed using the PLMN ID+Network ID (NID) so that it can point to the SNPN domain.

Alternatively, the Remote UE may have a valid UP-PRUK ID and KNRP freshness parameter 1 acquired during as illustrated in FIG. 4, e.g. during the method of the third embodiment or during previous U2N Relay communication over SNPN.

If the SUCI is provided in the DCR, then, in step S512, the U2N Relay stores the SUCI and other parameters such as the RSC, Nonce (control plane procedure), Freshness Parameter (user plane procedure) locally. (In case the PRUK/PRUK ID are provided in the DCR, then the U2N Relay can determine not to store these parameters.)

If the Remote UE is pre-authorized for SNPN access, has a valid UP-PRUK and sent a UP-PRUK ID in the DCR, then it skips step S514 and moves directly to step S516.

In case the SUCI is provided in the DCR and the Remote UE is not authorized previously for U2N Relay communication over SNPN access, then the UE-to-Network relay performs the Remote UE authorization for SNPN access in step S514, which includes a number of steps, S514a-S514e.

In step S514a, the U2N Relay sends a NAS transport message to the AMF, e.g., a SNPN access Request for the Remote UE, which includes the Remote UE's SUCI, for example in Network Access Identifier (NAI) format, and the RSC. Instead of defining a new message, an existing NAS message, e.g., NAS registration request message with the 5GS registration type set to “SNPN Onboarding of Remote UE for U2N Relay”, can be reused.

When the AMF receives the SNPN access Request for Remote UE message or NAS registration request message, it applies locally configured AMF Configuration Data for Onboarding or Remote UE to restrict UE network usage to only onboarding of Remote UE for U2N Relay and stores in the UE Context in the AMF an indication that the UE is registered for onboarding of Remote UE for U2N Relay. In step S514b, the AMF performs the AUSF selection as described in clause 5.30.2.10.2.6 of TS 23.501 v18.6.0, based on the ON-SNPN policies.

In step S514c, the authentication is performed as described in step 9 of clause I.2.2.2 in TS 33.501 v18.7.0 and uses PC 5 EAP messages between the Remote UE and U2N Relay as specified in 33.503v17.4.0 . The AMF may indicate that this is a relayed SNPN access (the indication may include, e.g. the RSC received from Relay), or may invoke a new operation in I.2.2.2 step 2 for ProSe CH primary authentication. The RSC would be useful for the Credentials Holder and the network functions in the AUSF to know which service is being requested and authorization would correspond to the RSC. Based on the presence of a relayed access indication and/or RSC, the AUSF may verify whether the UE can be allowed SNPN access via a U2N Relay. The AUSF may obtain subscription information from the UDM indicating UE info (UE ID and UE capability) to determine whether the SNPN access is allowed for the UE via a U2N Relay. For example, the subscription information may be associated with an indication that relayed SNPN access is allowed.

In step S514d, the AUSF sends an EAP success indication and may send the SUPI of the UE to the AMF/SEAF together with the resulting Key Security Anchor Function (KSEAF), and may include RSC(s) to indicate the authorized ProSe services for the Remote UE. Alternatively, based on the presence of a relayed SNPN indication and/or RSC, the AUSF refrains from sending SUPI or KSEAF to the AMF of the U2N Relay as the AMF of the U2N Relay may not need to establish a context for the Remote UE.

In step S514e, the U2N Relay receives a NAS transport message from the AMF, e.g., SNPN access Response for Remote UE, which includes an indication of EAP success, SUCI and RSC. Alternatively, an existing NAS message, e.g., NAS registration response message with the 5GS registration type set to “SNPN Onboarding of Remote UE for UE-to-Network Relay”, may be reused.

On condition of EAP success, the U2N Relay retrieves stored parameters SUCI, RSC, nonce for use in subsequent steps; otherwise, if the primary authentication is unsuccessful, the U2N Relay sends a Direct Communication (DC) reject message to the Remote UE with a cause code indicating that SNPN access is not authorized.

In step S516, the U2N Relay may send a Key Request to a 5G PKMF in the Credentials Holder and receive security credentials for the Remote UE, as described in steps 4a-4e in clause 6.3.3.2.2 in TS 33.503v18.4.0 .

Steps S518a-S518e correspond to steps 5 a-e in clause 6.3.3.2.2 of TS 33.503v18.4.0 . Notably, in step S518b, the Remote UE generates the UP-PRUK and UP-PRUK ID using the GPI received in step S518a via the U2N Relay.

The Remote UE and the U2N Relay can use procedures for relay service over the secure PC5 link, such as establishing a new PDU session and modifying an existing PDU session for relaying, if needed.

The fifth embodiment proposes Remote UE link establishment with U2N relay for relayed SNPN access over control plane. The Remote UE is authorized via U2N Relay for 5G ProSe U2N Relay communication with SNPN access over control plane. It is assumed that the U2N Relay is provisioned with the credentials from the Credentials Holder for SNPN access. The Remote UE may have the credentials from the Credentials Holder for SNPN access or not; both cases are described. In this illustrative example, separate Credentials Holder are shown for the Remote UE and the U2N Relay; however, they may be associated with the same CH, in which case they both be communicating with the same 5G PKMF, AUSF, PAnF and 5G DDNMF for authorization for ProSe services over SNPN access. It is also assumed that the Remote UE is out of coverage from its HPLMN or serving SNPN, and that the network is to be accessed via the U2N Relay communication with SNPN access over control plane.

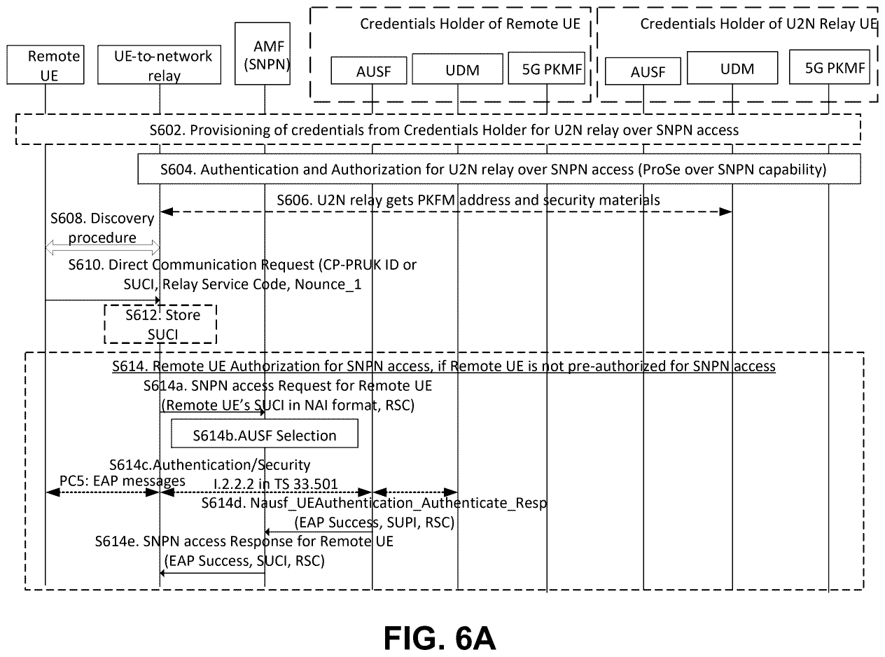

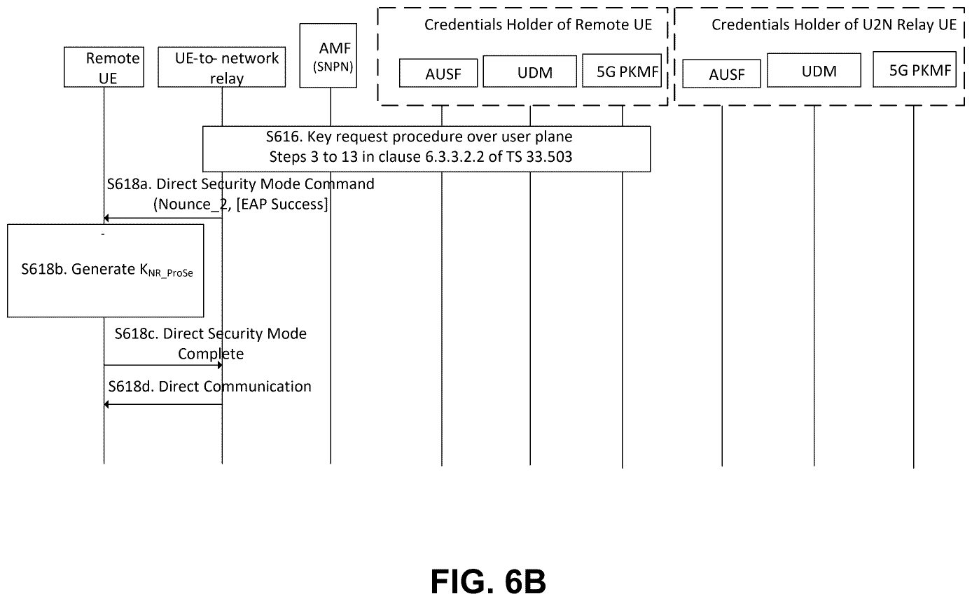

FIGS. 6A and 6B illustrate PC5 security establishment method for 5G ProSe UE-to-Network relay communication with SNPN access over User Plane according to an embodiment of the present principles.

The method illustrated in FIGS. 6A and 6B is generally like the method illustrated in FIGS. 5A and 5B with some differences.

In step S610, the DCR message includes CP-PRUK ID instead of UP-PRUK ID, and Nonce_1 instead of K_NRP Freshness Parameter 1.

Steps S618a-S618d (there is no step S618e) correspond to steps 14-17 in clause 6.3.3.3.2 of TS 33.503v18.4.0 . Notably, in step S618 b, the Remote UE generates the KNR_ProSe instead of the UP-PRUK and UP-PRUK ID.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method at a wireless transmit/receive unit, WTRU, the method comprising:
receiving, from a further WTRU, a request for communication, the request for communication comprising information indicative of key data associated with the further WTRU;
transmitting, to a first network, a request for access for the further WTRU to a further network, the request for access comprising information indicative of the key data;
receiving, from the first network, a response message comprising information indicative of an authentication result and of the key data;
in case the information indicative of the authentication result indicates successful authentication, transmitting a request for at least one key for the further WTRU;
receiving security credentials for the further WTRU; and
transmitting, to the further WTRU, the received security credentials.

2. The method of claim 1, wherein the key data is indicative of a subscription identifier.

3. The method of claim 1, wherein the request for communication further comprises information indicative of a code indicative of a relay service, and of at least one a key freshness indicator and a first nonce.

4. The method of claim 3, wherein the request for access and the response message further comprise information indicative of the code indicative of a relay service.

5. (canceled)

6. The method of claim 1, further comprising storing the information indicative of key data associated with the further WTRU.

7. The method of claim 6, further comprising, in response to the information indicative of the authentication result indicating successful authentication, retrieving the stored information indicative of key data associated with the further WTRU.

8. A wireless transmit/receive unit, WTRU, comprising at least one processor configured to:
receive, from a further WTRU, a request for communication, the request for communication comprising information indicative of key data associated with the further WTRU;
transmit, to a first network, a request for access for the further WTRU to a further network, the request for access comprising information indicative of the key data;
receive, from the first network, a response message comprising information indicative of an authentication result and of the key data;
in case the information indicative of the authentication result indicates successful authentication, transmit a request for at least one key for the further WTRU;
receive security credentials for the further WTRU; and
transmit, to the further WTRU, the received security credentials.

9. The WTRU of claim 8, wherein the key data is indicative of a subscription identifier.

10. The WTRU of claim 8, wherein the request for communication further comprises information indicative of a code indicative of a relay service, and of at least one a key freshness indicator and a first nonce.

11. The WTRU of claim 10, wherein the request for access and the response message further comprise information indicative of the code indicative of a relay service.

12. (canceled)

13. The WTRU of claim 8, wherein the at least one processor is further configured to store the information indicative of key data associated with the further WTRU.

14. The WTRU of claim 13, wherein the at least one processor is further configured to, in response to the information indicative of the authentication result indicating successful authentication, retrieve the stored information indicative of key data associated with the further WTRU.
